(19) United States
(12) Patent Application Publication
(10) Pub. No.: US 2024/0378916 A1
(43) Pub. Date: Nov. 14, 2024

(54) METHOD AND ELECTRONIC DEVICE FOR IMPROVING USER INPUT RECOGNITION PERFORMANCE

(71) Applicant: Samsung Electronics Co., Ltd., Suwon-si (KR)

(72) Inventors: Jeongwan PARK, Suwon-si (KR); Donghyuk LEE, Suwon-si (KR); Taewon KWAK, Suwon-si (KR); Jihoon KIM, Suwon-si (KR); Gwanyong PARK, Suwon-si (KR)

(21) Appl. No.: 18/784,220

(22) Filed: Jul. 25, 2024

Related U.S. Application Data
(63) Continuation of application No. PCT/KR2022/021619, filed on Dec. 29, 2022.

(30) Foreign Application Priority Data
Feb. 4, 2022 (KR) 10-2022-0015060

(51) Int. Cl. G06V 30/32; G06F 40/166; G06F 40/263; G06V 30/19; G06V 30/22

(52) U.S. Cl. CPC G06V 30/36; G06F 40/166; G06F 40/263; G06V 30/191; G06V 30/22; G06V 30/333

(57) ABSTRACT

An electronic device and a method of operating the same are provided. The electronic device includes memory storing one or more computer programs and a processor communicatively coupled to the memory, wherein the one or more computer programs include computer-executable instructions that, when executed by the processor individually or collectively, cause the electronic to receive a user input including a touch trajectory, determine whether the number of strokes of the user input exceeds a first reference value, in case that the number of strokes for the user input exceeds the first reference value, perform line separation for the user input into a first row and a second row, and in case that the number of strokes for the user input is equal to or smaller than the first reference value, perform syllable block recognition on the user input.

### CROSS-REFERENCE TO RELATED APPLICATION(S)

This application is a continuation application, claiming priority under § 365 (c), of an International application No. PCT/KR2022/021619, filed on Dec. 29, 2022, which is based on and claims the benefit of a Korean patent application number 10-2022-0015060, filed on Feb. 4, 2022, in the Korean Intellectual Property Office, the disclosure of which is incorporated by reference herein in its entirety.

### BACKGROUND

### 1. Field

The disclosure relates to a method and an electronic device for improving user input recognition performance.

### 2. Description of Related Art

With the development of digital technologies, various types of electronic devices, such as mobile communication terminals, personal digital assistants (PDAs), electronic organizers, smartphones, tablet personal computers (PCs), or wearable devices have become widely used. The hardware parts and/or software parts of such electronic devices are continually improving in order to improve support and increase functions thereof.

For example, the electronic device provides a function of allowing a user to write a necessary note anywhere and anytime without any notebook or pen. For example, the user may directly write on a display (for example, a touch screen) with a hand (for example, a finger) or an electronic pen. The electronic device may receive a touch trajectory (or a coordinate) of a touch on the display through handwriting. The user may input handwriting with an electronic pen as if writing a note with a pen, so as to conveniently take a note while feeling analog sensitivity.

The above information is presented as background information only to assist with an understanding of the disclosure. No determination has been made, and no assertion is made, as to whether any of the above might be applicable as prior art with regard to the disclosure.

### SUMMARY

When the user writes in a plurality of lines, the electronic device may recognize the lines of the input writing and separate the writing lines. The conventional electronic device may define and determine the relation between strokes of input handwriting by the rule or extract stroke features and apply a machine learning (for example, supervised learning or unsupervised learning) to separate the handwriting line. Although line separation should not be performed depending on the language, the line separation was conventionally performed and thus handwriting recognition performance was deteriorated in the prior art. Further, the handwriting recognition performance does not deteriorate in a scheme (for example, a printed style) separately writing two or more syllable blocks, but the handwriting recognition performance may somewhat deteriorate in a scheme (for example, a cursive style) of writing syllable blocks in one stroke in the prior art. In addition, the handwriting recognition performance may somewhat deteriorate when words that are not registered in the dictionary (out of vocabulary), such as an abbreviation or a new word, are input through handwriting in the prior art.

Aspects of the disclosure are to address at least the above-mentioned problems and/or disadvantages and to provide at least the advantages described below. Accordingly, an aspect of the disclosure is to provide a method and an apparatus for improving line separation performance for a user input (for example, a handwriting input), recognize a user input for writing syllable blocks of a second language in one stroke in first language recognition, separately perform recognition for the recognized user input, and constructing a personalized word database (DB) for words, such as an abbreviation or a new word.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, and a processor communicatively coupled to the memory, wherein the one or more computer programs include computer-executable instructions that, when executed by the processor individually or collectively, cause the electronic device to receive a user input including a touch trajectory, determine whether a number of strokes for the user input exceeds a first reference value, in case that the number of strokes for the user input exceeds the first reference value, perform line separation for the user input into a first row and a second row, and in case that the number of strokes for the user input is equal to or smaller than the first reference value, perform syllable block recognition for the user input.

In accordance with another aspect of the disclosure, a method of operating an electronic device is provided. The method includes receiving a user input including a touch trajectory, determining whether a number of strokes for the user input exceeds a first reference value, in case that the number of strokes for the user input exceeds the first reference value, performing line separation for the user input into a first row and a second row, and in case that the number of strokes for the user input is equal to or smaller than the first reference value, performing syllable block recognition for the user input.

According to various embodiments of the disclosure, the one or more computer programs further include computer-executable instructions that, when executed by the processor individually or collectively, cause the electronic device to perform line separation, based on the number of strokes for a user input (for example, handwriting) or a score according to syllable block recognition.

According to various embodiments of the disclosure, when an input (for example, handwriting) of continuously writing syllable blocks of a second language is detected in recognition of an input (for example, handwriting) for a first language, the one or more computer programs further include computer-executable instructions that, when executed by the processor individually or collectively, cause the electronic device to separate the first language and the second language and process recognition for each thereof.

According to various embodiments of the disclosure, when a user input is made in a handwriting input mode, the one or more computer programs further include computer-executable instructions that, when executed by the processor individually or collectively, cause the electronic device to collect edit text, learn the collected edit text, and process handwriting recognition even when a word that is not registered in the dictionary, such as an abbreviation or a new word, is input.

According to various embodiments of the disclosure, the one or more computer programs further include computer-executable instructions that, when executed by the processor individually or collectively, cause the electronic device to construct text for words frequently used by the user as a personalized text DB. Accordingly, a handwriting recognition rate for words that are misrecognized by a general word DB can be improved using the personalized text DB.

In accordance with another aspect of the disclosure, one or more non-transitory computer-readable storage media storing computer-executable instructions that, when executed by a processor individually or collectively, cause an electronic device to perform operations are provided. The operations include receiving a user input comprising a touch trajectory, determining whether a number of strokes for the user input exceeds a first reference value, in case that the number of strokes for the user input exceeds the first reference value, performing line separation for the user input into a first row and a second row, and in case that the number of strokes for the user input is equal to or smaller than the first reference value, performing syllable block recognition for the user input.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to an embodiment of the disclosure;

FIG. 2 is a flowchart illustrating a method of operating an electronic device according to an embodiment of the disclosure;

FIG. 3 illustrates an electronic device separates a user input line according to an embodiment of the disclosure;

FIG. 4 is a flowchart illustrating a method by which an electronic device separates a user input line according to an embodiment of the disclosure;

FIG. 5 is a flowchart illustrating a method by which an electronic device processes handwriting recognition according to an embodiment of the disclosure;

FIG. 6 illustrates an electronic device processes handwriting input in various schemes according to an embodiment of the disclosure;

FIG. 7 illustrates an electronic device processes handwriting input in various schemes according to an embodiment of the disclosure;

FIG. 8 is a flowchart illustrating a method by which an electronic device processes handwriting edit text according to an embodiment of the disclosure;

FIGS. 9A and 9B illustrate an electronic device processes handwriting edit text according to various embodiments of the disclosure;

FIG. 10 illustrates a user interface through which an electronic device receives an input of edit text according to an embodiment of the disclosure; and

FIGS. 11A and 11B illustrate a personalized text database (DB) in an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment of the disclosure, the “module” may be implemented in the form of an application-specific integrated circuit (ASIC).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

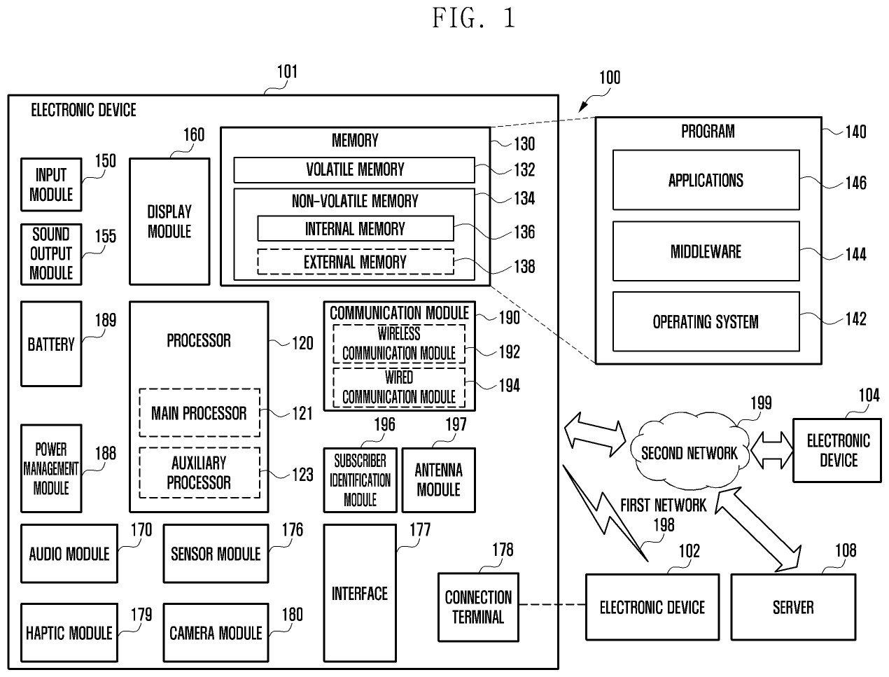

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave band)) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element composed of a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to certain embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each element (e.g., a module or a program) of the above-described elements may include a single entity or multiple entities, and some of the multiple entities mat be separately disposed in any other element. According to various embodiments of the disclosure, one or more of the above-described elements may be omitted, or one or more other elements may be added. Alternatively or additionally, a plurality of elements (e.g., modules or programs) may be integrated into a single element. In such a case, according to various embodiments of the disclosure, the integrated element may still perform one or more functions of each of the plurality of elements in the same or similar manner as they are performed by a corresponding one of the plurality of elements before the integration. According to various embodiments of the disclosure, operations performed by the module, the program, or another element may be carried out sequentially, in parallel, repeatedly, or heuristically, or one or more of the operations may be executed in a different order or omitted, or one or more other operations may be added.

An electronic device according to various embodiments of the disclosure may include memory (for example, the memory 130 of FIG. 1) and a processor (for example, the processor 120 of FIG. 1) operatively connected to the memory, wherein the processor may be configured to receive a user input including a touch trajectory, determine whether a number of strokes for the user input exceeds a first reference value, when the number of strokes for the user input exceeds the first reference value, perform line separation for the user input into a first row and a second row, and when the number of strokes for the user input is equal to or smaller than the first reference value, perform syllable block recognition for the user input.

The processor may be configured to calculate an input score, based on a similarity between a first character and a second character according to the syllable block recognition for the user input, determine whether the input score is smaller than a second reference value, when the input score is smaller than the second reference value, perform line separation for the user input, and when the input score is larger than or equal to the second reference value, not perform line separation for the user input.

In line separation for the user input, the processor may be configured to perform separation into a first row, a second row, or a third row.

The processor may be configured to learn a user input made in a style of writing syllable blocks in one stroke and determine whether the syllable blocks of the user input are input through the style in which the syllable blocks are written in one stroke through the learning.

When the user input is made in the style of writing the syllable blocks in one stroke, the processor may be configured to extract a user input area in which syllable blocks are written in one stroke and apply a second language recognition engine to the extracted user input area.

The processor may be configured to recognize a language of the user input, based on features extracted from the user input and, when the user input includes at least two languages, apply a language recognition engine corresponding to each language.

When the user input includes a first language and a second language, the processor may be configured to text-recognize a user input corresponding to the first language through a first language recognition engine and text-recognize a user input corresponding to the second language through a second language recognition engine.

The processor may be configured to recognize a language of the user input, based on a first language configured in the electronic device and, when a language that is not recognized as the first language is included, separate a user input area corresponding to the first language from a user input area corresponding to a second language.

When the user input corresponding to the second language is made in the style in which syllables are written in one stroke, the processor may be configured to separate the user input area corresponding to the first language from the user input area corresponding to the second language.

The processor may be configured to collect edit text corresponding to a user input, learn the collected edit text, and generate a personalized text DB, based on the learned edit text.

When the user input is converted into text, the processor may be configured to collect misrecognized text as the edit text, or provide a user interface for receiving an input of edit text and collect edit text input through the user interface.

The processor may be configured to perform text recognition for the user input, based on a general language model DB and the personalized text DB.

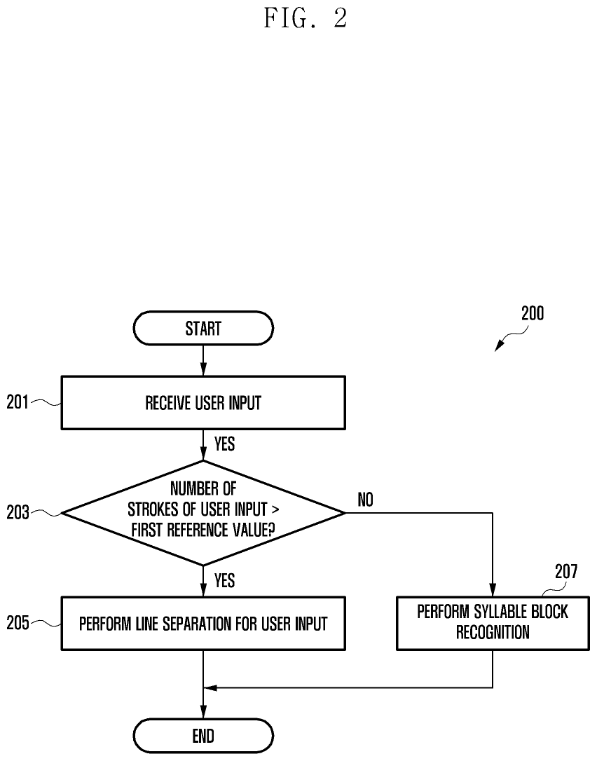

FIG. 2 is a flowchart 200 illustrating a method of operating an electronic device according to an embodiment of the disclosure.

Referring to FIG. 2, in operation 201, a processor (for example, the processor 120 of FIG. 1) of an electronic device (for example, the electronic device 101 of FIG. 1) according to various embodiments may receive a user input (for example, a handwriting input). Handwriting may be written data that is written by the user rather than data input by a keypad (or a keyboard). The user may input handwriting by touching a display (for example, the display module 160 of FIG. 1) of the electronic device 101 by using a user's body (for example, a finger) or an electronic pen. Further, the user may input handwriting by using hovering and a spatial touch without touching the display module 160 of the electronic device 101. When an input is made through a keypad by the processor 120, letters, symbols, or numbers may be input in a standardized writing type (or font).

Since handwriting is not the input through the keypad, the handwriting has the user's unique writing style. For example, the processor 120 may execute a memo application and receive a touch trajectory (or coordinate) input into an input area of the executed memo application as a handwriting input. Alternatively, when an input mode is changed to a writing input mode rather than the keypad, the processor 120 may receive a touch trajectory input into the input area as the handwriting input. In addition, the processor 120 may execute an application, configure a space as an input area of the executed application, and receive a touch trajectory (or coordinate) of the configured space as the handwriting input.

In operation 203, the processor 120 may determine whether the number of strokes of the user input exceeds a first reference value. The processor 120 may display a user input for receiving a user's touch trajectory on the display module 160 and determine whether the number of strokes of the user input exceeds the first reference value in response to the input received through the user input.

The first reference value is configured based on the number of strokes included in one letter and may be a stroke threshold. Since the number of strokes included in one letter is the same or different for a language of each country, the first reference value may be configured to be the same or different according to the language. For example, a first reference value configured for Korean may be higher or lower than a first reference value configured for Chinese. Alternatively, the first reference value configured for Korean may be equal to or lower than a first reference value configured in Japanese.

When the number of strokes of the user input exceeds the first reference value, it may be highly likely that the input strokes do not correspond to one letter. When the number of strokes of handwriting is equal to or lower than the first reference value, it may be highly likely that the input strokes correspond to one letter. The processor 120 may perform operation 205 when the number of strokes of handwriting exceeds the first reference value and may perform operation 207 when the number of strokes of handwriting is equal to or lower than the first reference value.

According to various embodiments of the disclosure, the processor 120 may extract features (or feature points) from the strokes of the handwriting. The handwriting may include strokes, and the stroke may be a line or point in writing or a picture (for example, a figure). The stroke may include points (for example, feature points), and the processor 120 may extract feature points from the strokes of the handwriting. For example, when the input handwriting is a number “1”, the processor 120 may divide 1 into three equal parts and extract three feature points in top, middle, and bottom parts. Alternatively, when the input handwriting is an alphabet “a”, the processor 120 may divide into three equal parts and extract three feature points in top, middle, and bottom parts.

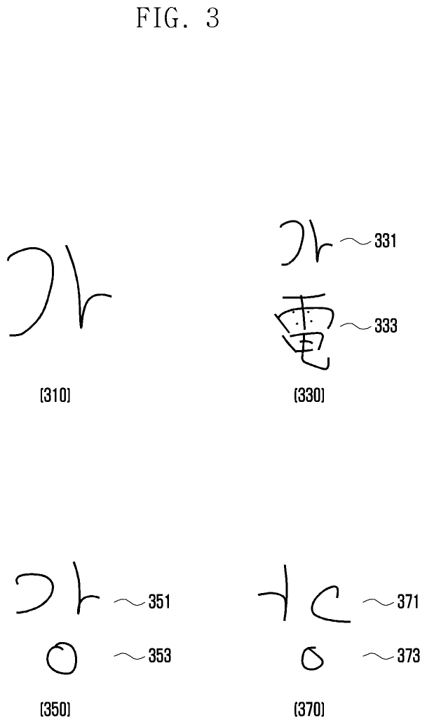

According to various embodiments of the disclosure, the processor 120 may extract a line separation result through a machine learning scheme based on neural network learning (for example, supervised learning). The line separation may separate handwriting lines by inferring the line merge relation between strokes through the conventional line separation scheme. The line may be top/bottom or left/right separation, based on a direction in which writing is made. For example, when writing is made in a horizontal direction, two lines may include a first line made in a horizontal direction and a second line made below or above the first line in a vertical direction. Since the line separation scheme corresponds to the conventional line separation scheme, a detailed description may be omitted. When line separation is determined according to the conventional line separation scheme, the processor 120 may perform operation 203. When line separation is not determined according to the conventional line separation scheme, the processor 120 may not separate the line of handwriting. For example, an example in which the line of handwriting is not separated may correspond to first handwriting 310 in FIG. 3.

When the number of strokes of the user input exceeds the first reference value, the processor 120 may separate the line of the user input in operation 205. Line separation may be top or bottom separation of the input handwriting. For example, when two handwritings of syllables are made, the processor 120 may recognize one handwriting as a first line and the other one handwriting as a second line. The first line and second line mean different rows. For example, an example of separating the handwriting line may correspond to second handwriting 330 of FIG. 3.

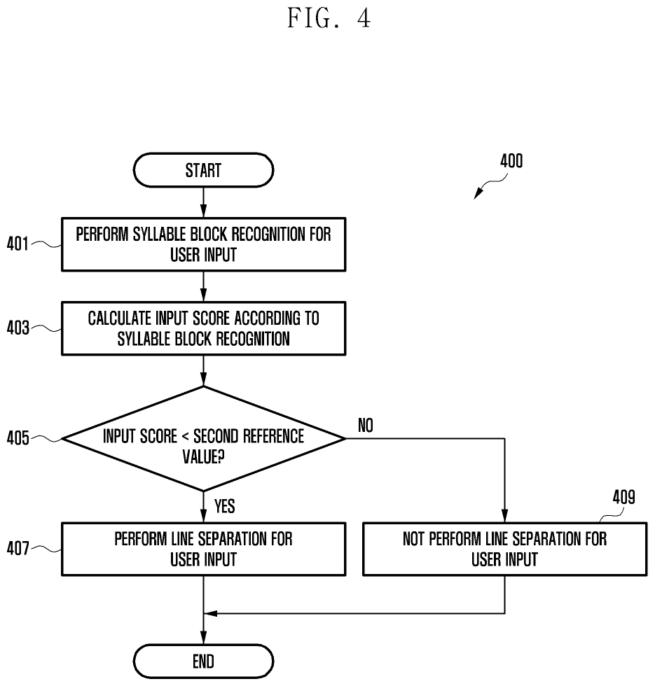

When the number of stroke of handwriting is equal to or lower than the first reference value, the processor 120 may perform syllable block recognition in operation 207. Syllable block recognition may be for increasing the accuracy of handwriting line separation. For example, when the line is separated only by the number of strokes of handwriting, line separation may be performed even when the line separation should not be performed or the line separation may not be performed even when the line separation should be performed. When the number of strokes of handwriting is equal to or lower than the first reference value, the processor 120 may determine line separation through syllable block recognition. Syllable block recognition may be performed to determine the similarity between handwritings. The similarity between handwritings may be calculated as a handwriting score and may be used to determine the line separation. When the handwriting score is higher than or equal to a second reference value, the processor 120 may not perform line separation because the similar between handwritings is high. When the handwriting score is lower than the second reference value, the processor 120 may perform line separation because the similarity between handwritings is low. A detailed description of the syllable block recognition is made in detail with reference to FIG. 4.

FIG. 3 illustrates an example in which an electronic device separates a user input line according to an embodiment of the disclosure.

Referring to FIG. 3, a processor (for example, the processor 120 of FIG. 1) of an electronic device (for example, the electronic device 101 of FIG. 1) according to various embodiments may determine line separation, based on features of a user input (for example, handwriting). For the first handwriting 310, the processor 120 may extract features from strokes of the first handwriting 310 and determine line separation, based on the features. For example, the processor 120 may not perform line separation according to features extracted from strokes of the first handwriting 310. For the second handwriting 330, when line separation is determined based on features extracted from strokes of the second handwriting 330, the processor 120 may determine whether the number of strokes of the second handwriting 330 exceeds the first reference value. The second handwriting 330 may include handwriting 331 in a first language and the second handwriting 330 in a second language. When the number of strokes (for example, 15) of the second handwriting 330 exceeds the first reference value (for example, 5), the processor 120 may perform line separation. The processor 120 may separate the handwriting 331 in the first language as a first line (for example, top) and separate handwriting 333 in the second language as a second line (for example, bottom) different from the first line.

For third handwriting 350, when line separation is determined based on features extracted from strokes of the third handwriting 350, the processor 120 may determine whether the number of strokes of the third handwriting 350 exceeds the first reference value. The third handwriting 350 may include handwriting 351 of first line and handwriting 353 of the second line. When the number of strokes (for example, 4) of the third handwriting 350 is equal to or lower than the first reference value (for example, 5), the processor 120 may perform syllable block recognition. The processor 120 may calculate a score of the third handwriting 350 through syllable block recognition for the third handwriting 350. The processor 120 may determine whether the score of the third handwriting 350 is lower than the second reference value. For example, when a range of the score of handwriting is 0 to 100, the second reference value may be 80. An example of the score range or the second reference value is to help in understanding of the disclosure and does not limit the disclosure. When the score of the third handwriting 350 is higher than or equal to the second reference value, the processor 120 may not perform line separation because the handwriting similarity is high. The processor 120 may not process line separation for the handwriting 351 of the first line and the handwriting 353 of the second line.

For fourth handwriting 370, when line separation is determined based on features extracted from strokes of the fourth handwriting 370, the processor 120 may determine whether the number of strokes of the fourth handwriting 370 exceeds the first reference value. The fourth handwriting 370 may include handwriting 371 of first line and handwriting 373 of the second line. When the number of strokes (for example, 4) of the fourth handwriting 370 is equal to or lower than the first reference value (for example, 5), the processor 120 may perform syllable block recognition. The processor 120 may calculate a score of the fourth handwriting 370 through syllable block recognition for the fourth handwriting 370. The processor 120 may determine whether the score of the fourth handwriting 370 is higher than or equal to the second reference value. When the score of the fourth handwriting 370 is lower than the second reference value, the processor 120 may perform line separation because the handwriting similarity is low. The processor 120 may separate the handwriting 371 of the first line (for example, top) from the handwriting 373 of the second line (for example, bottom) different from the first line.

FIG. 4 is a flowchart 400 illustrating a method of separating a user input line by an electronic device according to an embodiment of the disclosure. FIG. 4 may be a diagram that materializes operation 207 of FIG. 2.

Referring to FIG. 4, in operation 401, a processor (for example, the processor 120 of FIG. 1) of an electronic device (for example, the electronic device 101 of FIG. 1) according to various embodiments may perform syllable block recognition for a user input (for example, handwriting). The processor 120 may recognize a syllable block, based on strokes of handwriting or features extracted from the strokes of handwriting. For example, syllable block recognition may be recognition of the minimum unit of one syllable. The syllable may be a minimum unit of pronunciation that exits as one unit of language execution.

In operation 403, the processor 120 may calculate an input score according to the syllable block recognition. The input score (or handwriting score) indicates the similarity between writings, the high input score may indicate high handwriting similarity and the low input score may indicate low handwriting similarity. The processor 120 may transmit the input handwriting to a syllable block recognition engine and acquire a handwriting score.

In operation 405, the processor 120 may determine whether the input score is lower than the second reference value. For example, when a range of the input score is 0 to 100, the second reference value may be 80. An example of the score range or the second reference value is to help in understanding of the disclosure and does not limit the disclosure. The processor 120 may perform operation 407 when the input score is lower than the second reference value and perform operation 409 when the input score is higher than or equal to the second reference value.

When the input score is lower than the second reference value, the processor 120 may separate the line of the user input in operation 407. The low input score may mean the low handwriting similarity. In the case where the input score is low, it is highly likely that the handwriting is not one letter, and thus the processor 120 may separate the line of the handwriting into a first row and a second row. For example, an example of separating the handwriting line may correspond to fourth handwriting 370 of FIG. 3.

When the input score is higher than or equal to the second reference value, the processor 120 may not separate the user input line in operation 409. The high input score may mean the high handwriting similarity. In the case where the input score is high, it is highly likely that the handwriting corresponds to one letter, and thus the processor 120 may not separate the line of strokes of the handwriting. For example, an example in which the handwriting line is not separated may correspond to the third handwriting 350 of FIG. 3.

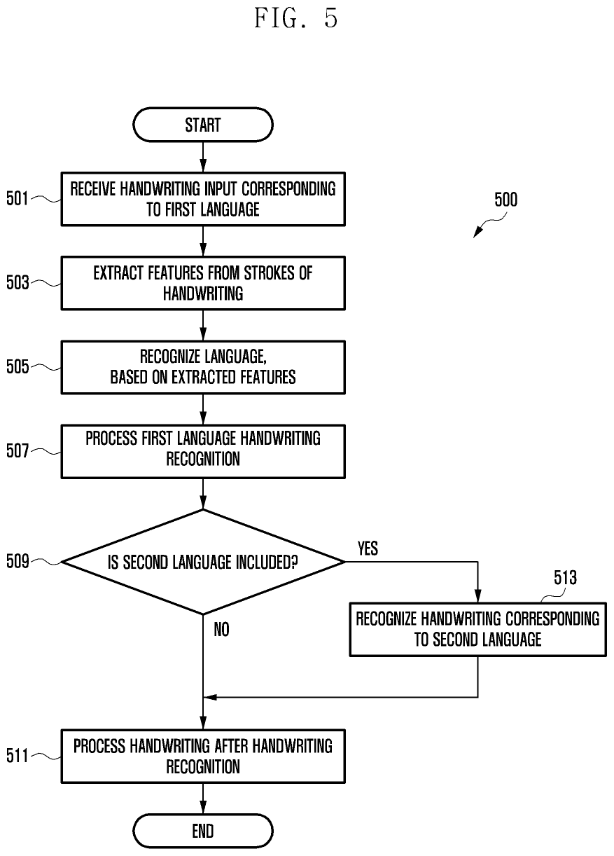

FIG. 5 is a flowchart 500 illustrating a method of processing handwriting recognition by an electronic device according to an embodiment of the disclosure. The method of FIG. 5 may be performed while the method of FIG. 2 or 4 is performed.

Referring to FIG. 5, in operation 501, a processor (for example, the processor 120 of FIG. 1) of an electronic device (for example, the electronic device 101 of FIG. 1) according to various embodiments may receive a handwriting input (for example, user input) corresponding to a first language. The first language may be a language, such as Korean, Chinese, or Japanese. The processor 120 may configure a language used by the electronic device 101 as the first language. According to an embodiment of the disclosure, the processor 120 may recognize a user input language and configure the same as the first language. The processor 120 may receive the handwriting input by touching a display (for example, the display module 160 of FIG. 1) of the electronic device 101 with a user's body (for example, finger) or an electronic pen. Operation 501 may be the same as or similar to operation 201 of FIG. 2.

In operation 503, the processor 120 may extract features (or feature points) from strokes of the handwriting. The handwriting may include strokes, and the stroke may be one line or point in writing or a picture. The stroke may include points (for example, feature points), and the processor 120 may extract feature points from the strokes of the handwriting. Operation 503 may be the same as or similar to operation 203 of FIG. 2.

In operation 505, the processor 120 may recognize the language, based on the extracted features. The processor 120 may recognize which country's letters correspond to the input handwriting, based on the features. The input handwriting may include a second language different from the first language in addition to the first language. The processor 120 may recognize the languages corresponding to the handwriting and separate a handwriting area (or part) corresponding to the first language and a handwriting area corresponding to the second language. The processor 120 may recognize letters for the input handwriting, based on a general language model DB and a personalized text DB.

In operation 507, the processor 120 may process handwriting corresponding to the first language. When the input handwriting includes the first language and the second language, the processor 120 may recognize the handwriting corresponding to the first language through a first language recognition engine. The input handwriting may include text (or letters) or non-text. Text means a visual symbol system used for writing a human's language and may include numbers or language letters of each country. Non-text is strokes that are not “letters” and may include underline below text, a figure, such as a circle, and a sketch (or picture). The processor 120 may classify the input handwriting into text or non-text and text-recognize the handwriting corresponding to the first language.

In operation 509, the processor 120 may determine whether the input handwriting includes the second language. The processor 120 may classify the handwriting that is not recognized as the first language through language recognition as the second language. For example, the second language is English, and English may be written and input in a first style (for example, printed style) in which two or more syllable blocks are separately written and a second style (for example, cursive style) in which syllable blocks are continuously written in one stroke). Although English is described as an example of the second language, any language that can be written and input in the first style or the second style can be understood as the second language. The processor 120 may lean the second language written in the second style. Learning may use various machine learning methods, such as multilayer perceptron (MLP), support vector machine (SVM), or deep learning.

According to various embodiments of the disclosure, the processor 120 may determine that the input handwriting is made in the second style through the learning. When the input handwriting is made in second style, the processor 120 may extract a handwriting area (for example, user input area) made in the second style and apply a second language recognition engine to the extracted handwriting area.

The processor 120 may perform operation 513 when the input handwriting does not include the second language, and perform operation 511 when the input handwriting does not include the second language.

In operation 513, the processor 120 may perform handwriting recognition corresponding to the second language. The processor 120 may transfer the handwriting corresponding to the second language to the second language recognition engine and perform the second language recognition. When the first language and the second language are simultaneously input by handwriting and the language of the handwriting is recognized through the first language recognition engine, the second language may not be properly recognized. Alternatively, when the second language is written in the second style, the second language may not be recognized through the first language recognition engine. The processor 120 may process the handwriting corresponding to the first language through the first language recognition engine and the handwriting corresponding to the second language through the second language recognition engine.

In operation 511, the processor 120 may process the handwriting after recognition (post-processing). When the handwriting includes only the first language, the processor 120 may recognize and process characters, such as numbers or symbols. When dash (-) is included between numbers, post-processing may be phone number processing. When the handwriting includes the first language and the second language, the processor 120 may combine a part corresponding to the processed first language and a part corresponding to the processed second language and then process the same.

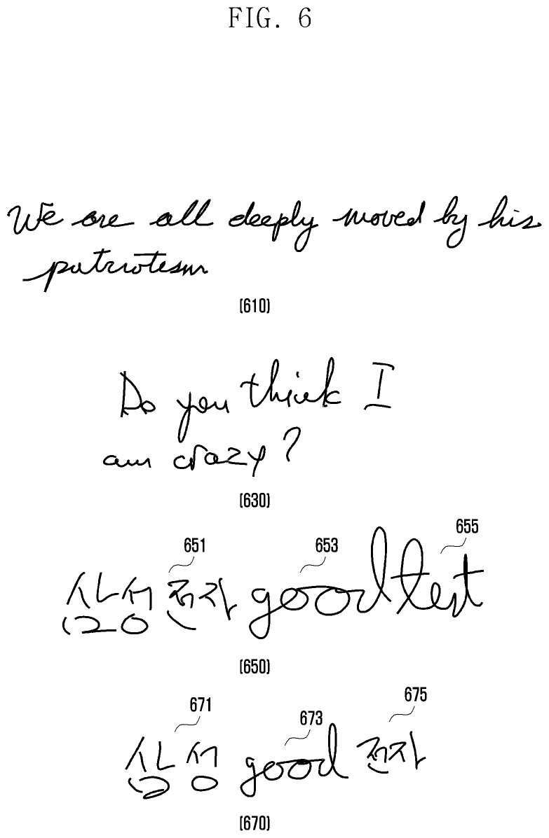

FIG. 6 illustrates an example in which an electronic device processes handwriting input in various schemes according to an embodiment of the disclosure.

Referring to FIG. 6, a processor (for example, the processor 120 of FIG. 1) of an electronic device (for example, the electronic device 101 of FIG. 1) according to various embodiments may text-recognize first handwriting 610 input in the second style in which syllable blocks are written in one stroke through the second language recognition engine. The processor 120 may text-recognize the first handwriting 610 as “We are all deeply moved by his patriotism”. For example, the processor 120 may identify that the first handwriting 610 is input in the second style in which each of “we”, “are”, and “all” is written in one stroke. Further, for second handwriting 630 input in the second style, the processor 120 may recognize text through the second language recognition engine. The processor 120 may text-recognize the second handwriting 630 as “Do you think I am crazy”. For example, it may be identified that the second handwriting 630 is input in the second style in which “Do”, “you”, and “think” are written in one stroke.

According to various embodiments of the disclosure, for third handwriting 650, the processor 120 may recognize text through the first language recognition engine and the second language recognition engine. The third handwriting 650 may include handwriting 3-1 651 corresponding to the first language and handwriting 3-2 653 and handwriting 3-3 655 corresponding to the second language. The processor 120 may recognize the third handwriting 650 as the first language configured in the electronic device 101 and when a language (for example, the second language) that is not the first language or a language input in the second style is detected based on the recognition result, the processor 120 may classify the third handwriting 650 into a first part (for example, handwriting 3-1 651) corresponding to the first language and a second part (for example, handwriting 3-2 653 and handwriting 3-3 655) corresponding to the second language. The processor 120 may apply the first language recognition engine to the first part and the second language recognition engine to the second part. The processor 120 may text-recognize the third handwriting 650 as “ [symbol] ”. For example, it may be identified that handwriting 3-2 653 and handwriting 3-3 655 are input in the second style in which one word (for example, good and test) is written in one stroke.

According to various embodiments of the disclosure, for the fourth handwriting 670, the processor 120 may recognize text through the first language recognition engine and the second language recognition engine. The fourth handwriting 670 may include handwriting 4-1 671 and handwriting 4-3 675 corresponding to the first language and handwriting 4-2 673 corresponding to the second language. The processor 120 may recognize the fourth handwriting 670 as the first language configured in the electronic device 101 and when a language (for example, the second language) that is not the first language or a language input in the second style is detected based on the recognition result, the processor 120 may classify the fourth handwriting 670 into a first part (for example, handwriting 4-1 671 and handwriting 4-3 675) corresponding to the first language and a second part (for example, handwriting 4-2 673) corresponding to the second language. The processor 120 may apply the first language recognition engine to the first part and the second language recognition engine to the second part. The processor 120 may text-recognize the fourth handwriting 670 as “ [symbol] good [symbol] ”. For example, it may be identified that handwriting 4-2 673 is input in the second style in which one word (for example, good) is written in one stroke.

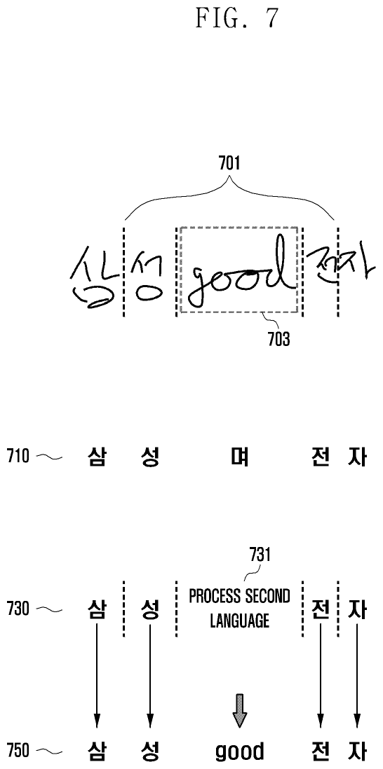

FIG. 7 illustrates another example in which an electronic device processes handwriting input in various schemes according to an embodiment of the disclosure.

Referring to FIG. 7, a processor (for example, the processor 120 of FIG. 1) of an electronic device (for example, the electronic device 101 of FIG. 1) according to various embodiments may text-recognize first handwriting 701 and 703 input in the second style in which syllable blocks are written in one stroke through the first language recognition engine and the second language recognition engine. In a comparative example 710, as the first handwriting 701 and 703 may be processed through the first language recognition engine, text recognition of “ [symbol] ” may be performed. In the disclosure, the first handwriting 701 and 703 may be divided into a first part and a second part, and the parts may be separately processed. For example, referring to a first reference numeral 730, the processor 120 may apply the first language recognition engine to the first part and apply the second language recognition engine to the second part, so as to perform second language processing 731.

Referring to a second reference numeral 750, the first language may be processed for the first part and text-recognized as “ [symbol] ” and the second language may be processed for the second part and text-recognized as “good”. The processor 120 may place text (for example, [symbol] ) corresponding to the first part and text (for example, good) corresponding to the second part at locations input as the first handwriting 701 and 703, and process the text as “ [symbol] good [symbol] ”.

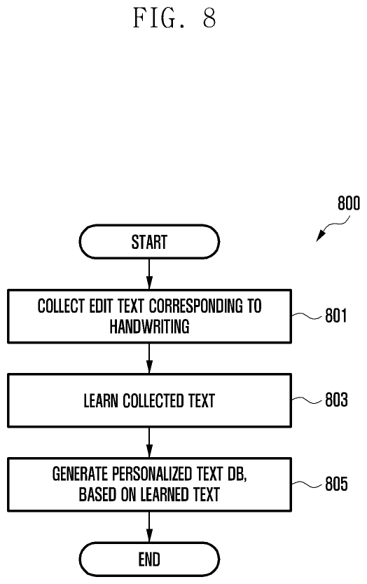

FIG. 8 is a flowchart 800 illustrating a method by which an electronic device processes handwriting edit text according to an embodiment of the disclosure.

Referring to FIG. 8, in operation 801, a processor (for example, the processor 120 of FIG. 1) of an electronic device (for example, the electronic device 101 of FIG. 1) according to various embodiments may collect edit text corresponding to handwriting. The edit text may be a word obtained by modifying text by the user after recognition of the text corresponding to handwriting. For example, when the user input a word that is not registered in the dictionary (out of vocabulary), such as an abbreviation or a new word, through handwriting, the processor 120 may recognize the word as text different from the handwriting. In this case, the user may edit the text-recognized text. For words that are not registered in the dictionary, the disclosure may collect words that the user frequently uses in order to prevent handwriting recognition performance from deteriorating. The edit text may be understood as a user word or a personalized word.

According to various embodiments of the disclosure, the processor 120 may collect the edit text in various methods. For example, when handwriting is converted into text, if an edit situation is generated due to misrecognition, edit text may be stored. Alternatively, the processor 120 may provide a user interface for directly receiving an input of edit text from the user and store the edit text input through the user interface.

In operation 803, the processor 120 may learn the collected text (for example, edit text). The processor 120 may store the collected edit text in memory (for example, the memory 130 of FIG. 1). The processor 120 may learn a text (or word) model personalized in the electronic device 101, based on the text stored in the memory 130. The learning may be performed at a time (for example, night or dawn) during which the electronic device 101 is not used or a time configured by the user. The processor 120 may learn the personalized text model by preprocessing (for example, filtering or language-processing) the collected text.

In operation 805, the processor 120 may generate a personalized text DB, based on learned text (for example, edit text). The processor 120 may convert the learned text into a binary code and process the same to be the state for a database. The processor 120 may store the generated personalized text DB in the memory 130. The personalized text DB stored in the electronic device 101 of the first user may be different from the personalized text DB stored in the external electronic device 102 of the second user. Since words frequently used by the first user and the second user are different from each other, the personalized text DBs may be different from each other.

In text recognition of handwriting, the processor 120 may use the general language model DB and the personalized text DB together. The processor 120 may improve the text recognition performance by performing text recognition for handwriting, based on the general language model DB and the personalized text DB.

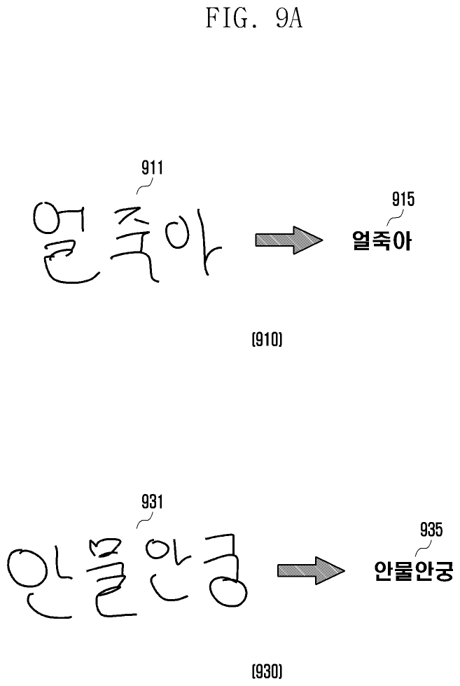

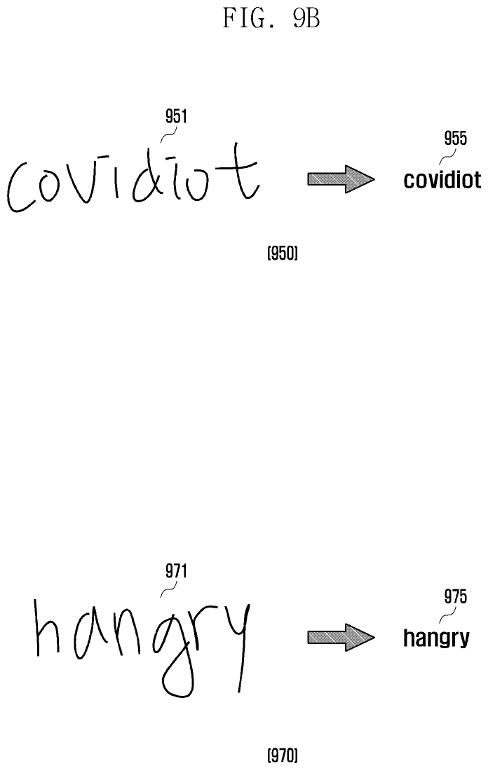

FIGS. 9A and 9B illustrate examples in which an electronic device processes handwriting edit text according to various embodiments of the disclosure.

Referring to FIG. 9A, a processor (for example, the processor 120 of FIG. 1) of an electronic device (for example, the electronic device 101 of FIG. 1) according to various embodiments may use the personalized text DB in text recognition for first handwriting 911 or second handwriting 931. Referring to a first reference numeral 910, the first handwriting 911 may be text-recognized as [symbol] 915 using the personalized text DB in the disclosure. Referring to a second reference numeral 930, the second handwriting 931 may be text-recognized as [symbol] 935 using the personalized text DB in the disclosure.

Referring to FIG. 9B, the processor 120 may use the personalized text DB in text recognition for third handwriting 951 or fourth handwriting 971. Referring to a third reference numeral 950, the third handwriting 951 may be text-recognized as covidiot 955 using the personalized text DB in the disclosure. Referring to a fourth reference numeral 970, the fourth handwriting 971 may be text-recognized as hangry 975 using the personalized text DB in the disclosure.

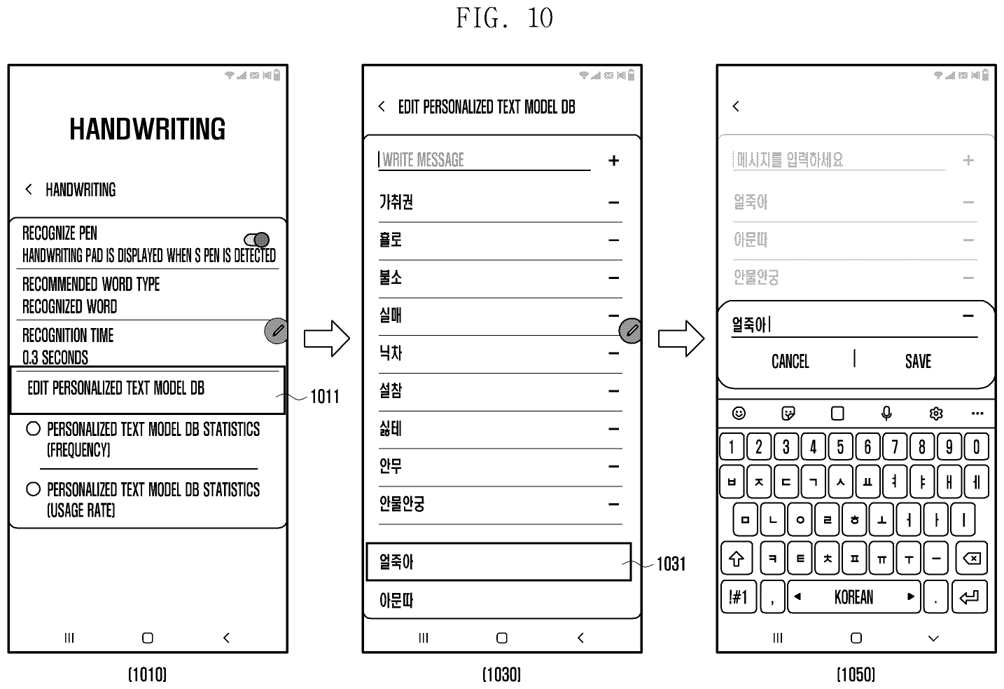

FIG. 10 illustrates a user interface through which an electronic device receives an input of edit text according to an embodiment of the disclosure.

Referring to FIG. 10, a processor (for example, the processor 120 of FIG. 1) of an electronic device (for example, the electronic device 101 of FIG. 1) according to various embodiments may provide (or display) a user interface for collecting edit text and receive an input of edit text from the user through the user interface. A first user interface 1010 may be for editing an edit text DB related to handwriting. The first user interface 1010 may be displayed on a display (for example, the display module 160 of FIG. 1) of the electronic device 101. When personalized DB text edit 1011 is selected in the first user interface 1010, the processor 120 may provide a second user interface 1030. The second user interface 1030 may include a text list including one or more edit text stored in the personalized text DB. When at least one edit text 1031 is selected in the second user interface 1030, the processor 120 may provide a third user interface 1050. The third user interface 1050 is for modifying (or editing) edit text and may include a keypad. For example, when save is selected after [symbol] is modified, modified text for [symbol] may be stored in the personalized text DB.

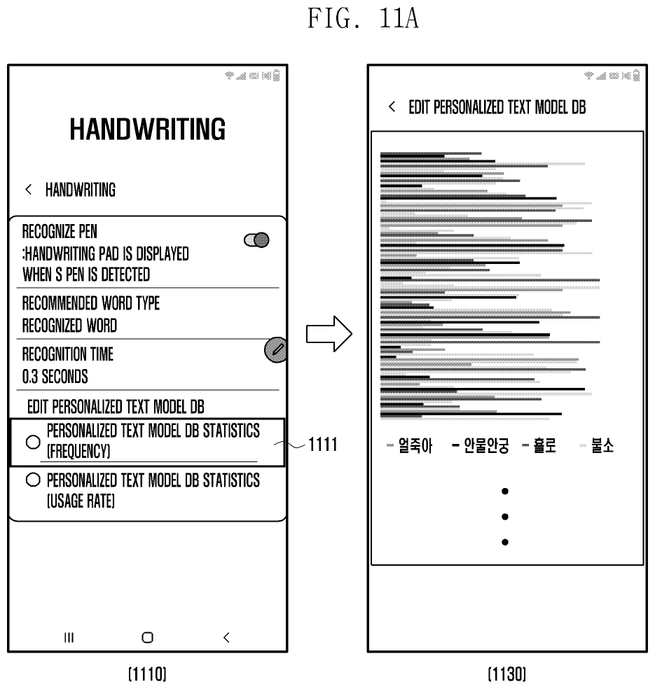

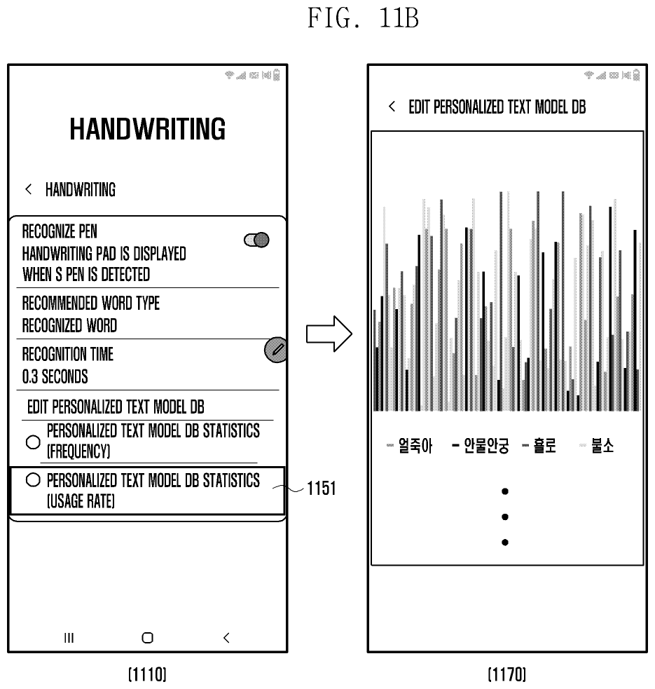

FIGS. 11A and 11B illustrate a personalized text DB in an electronic device according to various embodiments of the disclosure.

Referring to FIG. 11A, a processor (for example, the processor 120 of FIG. 1) of an electronic device (for example, the electronic device 101 of FIG. 1) according to various embodiments may provide statistics for edit text. A first user interface 1110 may be for editing an edit text DB related to handwriting. The first user interface 1110 may be displayed on a display (for example, the display module 160 of FIG. 1) of the electronic device 101. When personalized text DB statistics (frequency) 1111 is selected in the first user interface 1110, the processor 120 may provide a second user interface 1130. The second user interface 1130 may include frequency of one or more edit text stored in the personalized text DB. The second user interface 1130 may indicate the frequency for each edit text in percentage terms.

Referring to FIG. 11B, when personalized text DB statistics (the first user interface 1110 (usage rate) 1151 is selected in the first user interface 1110, the processor 120 may provide a third user interface 1170. The third user interface 1170 may include a usage rate for one or more edit text stored in the personalized text DB. The third user interface 1170 may indicate the usage rate for each edit text in percentage terms.

A method of operating an electronic device (for example, the electronic device 101 of FIG. 1) according to various embodiments of the disclosure may include an operation of receiving a user input including a touch trajectory, an operation of determining whether a number of strokes for the user input exceeds a first reference value, an operation of, when the number of strokes for the user input exceeds the first reference value, performing line separation for the user input into a first row and a second row, and an operation of when the number of strokes for the user input is equal to or smaller than the first reference value, performing syllable block recognition for the user input.

The method may further include an operation of calculating an input score, based on a similarity between a first character and a second character according to the syllable block recognition for the user input, an operation of determining whether the input score is smaller than a second reference value, an operation of, when the input score is smaller than the second reference value, performing line separation for the user input, and an operation of, when the input score is larger than or equal to the second reference value, not performing line separation for the user input.

The operation of performing the line separation may include an operation of performing line separation into a first row, a second row, or a third row in the line separation for the user input.

The method may further include an operation of learning a user input made in a style of writing syllable blocks in one stroke and an operation of determining whether the syllable blocks of the user input are input through the style in which the syllable blocks are written in one stroke through the learning.

When user input is made in the style of writing the syllable blocks in one stroke, the method may further include an operation of extracting a user input area in which syllable blocks are written in one stroke and an operation of applying a second language recognition engine to the extracted user input area.

The method may further include an operation of recognizing a language of the user input, based on features extracted from the user input and an operation of, when the user input includes a first language and a second language, text-recognizing a user input corresponding to the first language through a first language recognition engine and text-recognizing a user input corresponding to the second language through a second language recognition engine.

The method may further include an operation of collecting edit text corresponding to a user input, an operation of learning the collected edit text, and an operation of generating a personalized text DB, based on the learned edit text.

The method may further include an operation of performing text recognition for the user interface, based on a general language model DB and the personalized text DB.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs; and
a processor communicatively coupled to the memory,
wherein the one or more computer programs include computer-executable instructions that, when executed by the processor individually or collectively, cause the electronic device to:
receive a user input comprising a touch trajectory,
determine whether a number of strokes for the user input exceeds a first reference value,
in case that the number of strokes for the user input exceeds the first reference value, perform line separation for the user input into a first row and a second row, and
in case that the number of strokes for the user input is equal to or smaller than the first reference value, perform syllable block recognition for the user input.

2. The electronic device of claim 1, wherein the one or more computer programs further include computer-executable instructions that, when executed by the processor individually or collectively, cause the electronic device to:
calculate an input score, based on a similarity between a first character and a second character according to the syllable block recognition for the user input,
determine whether the input score is smaller than a second reference value,
in case that the input score is smaller than the second reference value, perform line separation for the user input, and
in case that the input score is larger than or equal to the second reference value, not perform line separation for the user input.

3. The electronic device of claim 1, wherein the one or more computer programs further include computer-executable instructions that, when executed by the processor individually or collectively, cause the electronic device to, in line separation for the user input, perform separation into a first row, a second row, or a third row.

4. The electronic device of claim 1, wherein the one or more computer programs further include computer-executable instructions that, when executed by the processor individually or collectively, cause the electronic device to:
learn a user input made in a style of writing syllable blocks in one stroke, and
determine whether the syllable blocks of the user input are input through the style in which the syllable blocks are written in one stroke through the learning.

5. The electronic device of claim 4, wherein the one or more computer programs further include computer-executable instructions that, when executed by the processor individually or collectively, cause the electronic device to, in case that the user input is made in the style of writing the syllable blocks in one stroke:
extract a user input area in which syllable blocks are written in one stroke, and
apply a second language recognition engine to the extracted user input area.

6. The electronic device of claim 1, wherein the one or more computer programs further include computer-executable instructions that, when executed by the processor individually or collectively, cause the electronic device to:
recognize a language of the user input, based on features extracted from the user input, and
in case that the user input comprises at least two languages, apply a language recognition engine corresponding to each language.

7. The electronic device of claim 6, wherein the one or more computer programs further include computer-executable instructions that, when executed by the processor individually or collectively, cause the electronic device to, in case that the user input comprises a first language and a second language, text-recognize a user input corresponding to the first language through a first language recognition engine and text-recognize a user input corresponding to the second language through a second language recognition engine.

8. The electronic device of claim 5, wherein the one or more computer programs further include computer-executable instructions that, when executed by the processor individually or collectively, cause the electronic device to:
recognize a language of the user input, based on a first language configured in the electronic device, and
in case that a language that is not recognized as the first language is included, separate a user input area corresponding to the first language from a user input area corresponding to a second language.

9. The electronic device of claim 8, wherein the one or more computer programs further include computer-executable instructions that, when executed by the processor individually or collectively, cause the electronic device to, in case that the user input corresponding to the second language is made in the style in which syllables are written in one stroke, separate the user input area corresponding to the first language from the user input area corresponding to the second language.

10. The electronic device of claim 1, wherein the one or more computer programs further include computer-executable instructions that, when executed by the processor individually or collectively, cause the electronic device to:
collect edit text corresponding to a user input,
learn the collected edit text, and
generate a personalized text DB, based on the learned edit text.

11. The electronic device of claim 10, wherein the one or more computer programs further include computer-executable instructions that, when executed by the processor individually or collectively, cause the electronic device to:
in case that the user input is converted into text, collect misrecognized text as the edit text, or
provide a user interface for receiving an input of edit text and collect edit text input through the user interface.

12. The electronic device of claim 10, wherein the one or more computer programs further include computer-executable instructions that, when executed by the processor individually or collectively, cause the electronic device to perform text recognition for the user interface, based on a general language model DB and the personalized text DB.

13. A method of operating an electronic device, the method comprising:
receiving a user input comprising a touch trajectory;
determining whether a number of strokes for the user input exceeds a first reference value;
in case that the number of strokes for the user input exceeds the first reference value, performing line separation for the user input into a first row and a second row; and
in case that the number of strokes for the user input is equal to or smaller than the first reference value, performing syllable block recognition for the user input.

14. The method of claim 13, further comprising:
calculating an input score, based on a similarity between a first character and a second character according to the syllable block recognition for the user input;
determining whether the input score is smaller than a second reference value;
in case that the input score is smaller than the second reference value, performing line separation for the user input; and
in case that the input score is larger than or equal to the second reference value, not performing line separation for the user input.

15. The method of claim 13, wherein the performing of the line separation comprises performing line separation into a first row, a second row, or a third row in the line separation for the user input.

16. The method device of claim 13, further comprising:
learning a user input made in a style of writing syllable blocks in one stroke; and
determining whether the syllable blocks of the user input are input through the style in which the syllable blocks are written in one stroke through the learning.

17. The method device of claim 16, further comprising, in case that the user input is made in the style of writing the syllable blocks in one stroke:
extracting a user input area in which syllable blocks are written in one stroke; and
applying a second language recognition engine to the extracted user input area.

18. The method device of claim 13, further comprising:
recognizing a language of the user input, based on features extracted from the user input; and
in case that the user input comprises at least two languages, applying a language recognition engine corresponding to each language.

19. One or more non-transitory computer-readable storage media storing computer-executable instructions that, when executed by a processor individually or collectively, cause an electronic device to perform operations, the operations comprising:
receiving a user input comprising a touch trajectory;
determining whether a number of strokes for the user input exceeds a first reference value;
in case that the number of strokes for the user input exceeds the first reference value, performing line separation for the user input into a first row and a second row; and
in case that the number of strokes for the user input is equal to or smaller than the first reference value, performing syllable block recognition for the user input.

20. The one or more non-transitory computer-readable storage media of claim 19, further comprising:
calculating an input score, based on a similarity between a first character and a second character according to the syllable block recognition for the user input;
determining whether the input score is smaller than a second reference value;
in case that the input score is smaller than the second reference value, performing line separation for the user input; and
in case that the input score is larger than or equal to the second reference value, not performing line separation for the user input.
